(19) United States
(12) Patent Application Publication
(10) Pub. No.: US 2026/0152058 A1
(43) Pub. Date: Jun. 4, 2026

(54) VEHICLE DRIVE APPARATUS

(71) Applicant: TOYOTA JIDOSHA KABUSHIKI KAISHA, Toyota-shi (JP)

(72) Inventors: Hirotsugu YOSHINO, Numazu-shi (JP); Daiki Kurihara, Atsugi-shi (JP)

(73) Assignee: TOYOTA JIDOSHA KABUSHIKI KAISHA, Toyota-shi (JP)

(21) Appl. No.: 19/390,945

(22) Filed: Nov. 17, 2025

(30) Foreign Application Priority Data
Nov. 29, 2024 (JP) 2024-209130

(51) Int. Cl. B60K 17/16; B60K 1/02

(52) U.S. Cl. CPC B60K 17/16; B60K 1/02

(57) ABSTRACT

A vehicle drive apparatus includes: (a) a prime mover; (b) a power transmission mechanism disposed on a first axis and configured to transmit a power from the prime mover; (c) an output shaft disposed on a second axis other than the first axis and configured to transmit the power to a pair of axles; (d) a belt configured to transmit the power from the power transmission mechanism to the output shaft; and (e) a parking lock mechanism configured to inhibit rotation of the axles. The parking lock mechanism is disposed on a downstream side of the belt in a power transmission path through which the power is to be transmitted from the prime mover to the axles.

This application claims priority from Japanese Patent Application No. 2024-209130 filed on Nov. 29, 2024, the disclosure of which is herein incorporated by reference in its entirety.

### FIELD OF THE INVENTION

The present invention relates to a vehicle drive apparatus including a prime mover, a power transmission mechanism configured to transmit a power from the prime mover, a belt configured to transmit the power from the power transmission mechanism to an output shaft, and a parking lock mechanism configured to inhibit rotation of a pair of axles.

### BACKGROUND OF THE INVENTION

There is known a vehicle drive apparatus including (a) a prime mover, (b) a power transmission mechanism disposed on a first axis and configured to transmit a power from the prime mover, (c) an output shaft disposed on a second axis other than the first axis and configured to transmit the power to a pair of axles, and (d) a belt configured to transmit the power from the power transmission mechanism to the output shaft. For example, Patent Document 1 discloses such a vehicle drive apparatus. In Patent Document 1, there is no description of a parking lock mechanism configured to inhibit rotation of a pair of axles.

### PRIOR ART DOCUMENT

### Patent Document

### [Patent Document 1]

Japanese Patent Application Laid-Open No. 5-85207

### SUMMARY OF THE INVENTION

By the way, in the vehicle drive apparatus disclosed in Patent Document 1, depending on a position in which the parking lock mechanism is disposed, there is a risk that the axles could be moved or rotated due to deflection of the belt when a parking brake is released, and there is a risk that durability of the belt could be reduced due to an impact load transmitted to the belt when operation of the parking lock mechanism is started.

The present invention has been made in view of the above circumstances, and an object of the present invention is to provide a vehicle drive apparatus capable of suppressing movement of axles when a parking brake is released and suppressing reduction of durability of a belt due to an impact load when operation of a parking lock mechanism is started.

The present invention provides a vehicle drive apparatus including: (a) a prime mover; (b) a power transmission mechanism disposed on a first axis and configured to transmit a power from the prime mover; (c) an output shaft disposed on a second axis other than the first axis and configured to transmit the power to a pair of axles; (d) a belt configured to transmit the power from the power transmission mechanism to the output shaft; and (d) a parking lock mechanism configured to inhibit rotation of the axles. The parking lock mechanism is disposed on a downstream side of the belt in a power transmission path through which the power is to be transmitted from the prime mover to the axles. In other words, the parking lock mechanism is disposed between the belt and the axles in the power transmission path.

In the vehicle drive apparatus according to the present invention, the parking lock mechanism is disposed on the downstream side of the belt in a power transmission path. Thus, it is possible to suppressing the axles from being moved or rotated due to deflection of the belt when a parking brake is released, and to reduce an impact load applied from the parking lock mechanism from to the belt when the parking lock mechanism starts to be operated, thereby suppressing reduction of durability of the belt.

### BRIEF DESCRIPTION OF THE DRAWINGS

FIG. 1 is a schematic view showing a vehicle equipped with a vehicle drive apparatus according to a first embodiment of the present invention;

FIG. 2 is a collinear chart for explaining BEV_MG2 mode;

FIG. 3 is a collinear chart for explaining series mode;

FIGS. 4A and 4B are collinear charts for explaining output-split mode;

FIG. 5 is a schematic view showing a vehicle equipped with a vehicle drive apparatus according to a second embodiment of the present invention; and

FIG. 6 is a schematic view showing a vehicle equipped with a vehicle drive apparatus according to a third embodiment of the present invention.

### DETAILED DESCRIPTION OF PREFERRED EMBODIMENTS

Hereinafter, some embodiments of the present invention will be described in detail with reference to the drawings. Unless otherwise specified, in each embodiment, the drawings are simplified or modified as appropriate, and the dimensional ratio, shape and the like of each part are not necessarily accurately drawn in the drawings.

### First Embodiment

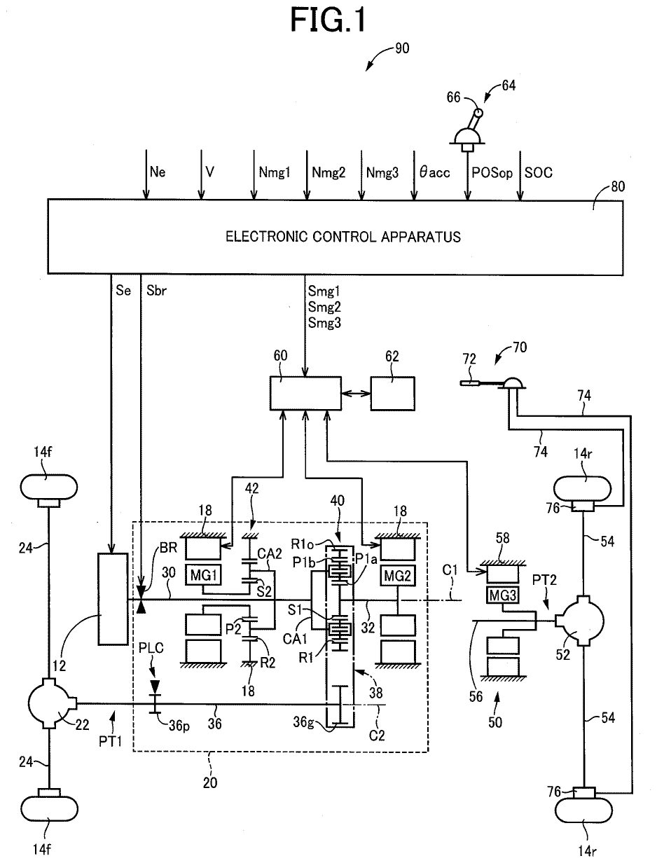

FIG. 1 is a schematic view showing a vehicle 90 equipped with a vehicle drive apparatus 10 according to a first embodiment of the present invention.

The vehicle 90 is a hybrid vehicle. For example, the vehicle 90 is an HEV (Hybrid Electric Vehicle) vehicle or a PHEV (Plug-in Hybrid Electric Vehicle) vehicle. Further, the vehicle 90 is an all-wheel drive vehicle capable of independently driving left and right front wheels 14f and left and right rear wheels 14r. An all-wheel drive (AWD) and a four-wheel drive (4WD) are synonymous with each other. The above-described “left and right” are left and right with respect to a forward direction of the vehicle 90. In the following descriptions, the “left and right front wheels 14f” and the “left and right rear wheels 14r” are simply referred to as “front wheels 14f” and “rear wheels 14r”.

The vehicle 90 has a first power transmission path PT1 between the engine 12 and the front wheels 14f. The engine 12 is a power source for driving the vehicle 90, and is a well-known internal-combustion engine. The engine 12 is controlled by an electronic control apparatus 80 such that an engine torque Te [N·m] that is an output torque of the engine 12 is controlled by the electronic control apparatus 80. In the present specification, “torque”, “driving force”, “power” and “force (=power)” are synonymous with one other, unless otherwise specified. During a two-wheel drive mode (=during running in 2WD), the front wheels 14f or the rear wheels 14r serve as drive wheels. During a four-wheel drive mode (=during running in 4WD), both the front wheels 14f and the rear wheels 14r serve as the drive wheels. The engine 12 corresponds to “prime mover” recited in the appended claims.

The first power transmission path PT1 is provided with, in order from the engine 12 side, a front drive unit 20, a front differential gear device 22 and left and right front drive shafts 24, and has a well-known configuration except for the front drive unit 20. Hereinafter, the left and right front drive shafts 24 will be simply referred to as “front drive shafts 24”. The front drive unit 20 is a unit configured to drive the front wheels 14f. The front differential gear device 22 corresponds to “differential gear device” recited in the appended claims. The front drive shafts 24 correspond to “pair of axles” or “first pair of axles” recited in the appended claims.

The front drive unit 20 includes a first electric motor MG1, a second electric motor MG2, a first planetary gear device 40 and a second planetary gear device 42. Each of the first and second planetary gear devices 40, 42 has three rotary elements. Each of the first and second electric motors MG1, MG2 is a rotating electric machine, i.e., a so-called motor generator that functions as both of an electric motor and a generator, and is, for example, a three-phase synchronous electric motor. The detailed configuration of the front drive unit 20 will be described later.

The vehicle 90 has a second power transmission path PT2 between a third electric motor MG3 and the rear wheels 14r. The third electric motor MG3 is a power source for driving the vehicle 90. The third electric motor MG3 is a rotating electric machine, i.e., a so-called motor generator that has a function of an electric motor, or functions of both of an electric motor and a generator, and is, for example, a three-phase synchronous electric motor.

The second power transmission path PT2 is provided with, in order from the third electric motor MG3 side, a transmission shaft 56, a rear differential gear device 52 and left and right rear drive shafts 54, which are of a well-known configuration. The third electric motor MG3 is connected to the transmission shaft 56. Hereinafter, the left and right rear drive shafts 54 will be simply referred to as “rear drive shafts 54”. The transmission shaft 56 and the third electric motor MG3 constitute a rear drive unit 50. The rear drive unit 50 is a unit configured to drive the rear wheels 14r. The detailed configuration of the rear drive unit 50 will be described later. The rear drive shafts 54 corresponds to “second pair of axles” recited in the appended claims.

The vehicle 90 includes an inverter 60, a battery 62 and the above-described electronic control apparatus 80.

The inverter 60 is a well-known power supply circuit configured to convert DC to AC and AC to DC. Each of the first electric motor MG1, second electric motor MG2 and third electric motor MG3 is connected to the battery 62 via the inverter 60. The torques of the first electric motor MG1, second electric motor MG2 and third electric motor MG3 is controlled by the electronic control apparatus 80 that controls the inverter 60. The output torque of the first electric motor MG1 is a first electric motor torque Tmg1 [N·m], the output torque of the second electric motor MG2 is a second electric motor torque Tmg2 [N·m], and the output torque of the third electric motor MG3 is a third electric motor torque Tmg3 [N·m]. When the electric motors function as electric motors, the torques serve as powering torque. When the electric motors function as generators, the torques serve as regenerative torques. The battery 62 is an electricity storage device configured to supply and receive the power to and from each of the first electric motor MG1, second electric motor MG2 and third electric motor MG3. For example, the first electric motor MG1, second electric motor MG2 and third electric motor MG3 are controlled via the inverter 60 such that the powers are supplied and received simultaneously. The term “simultaneously” means, for example, that first electric motor MG1, second electric motor MG2, and third electric motor MG3 are capable of powering or regenerating independently and simultaneously.

Thus, the vehicle drive apparatus 10 includes the engine 12, the front drive unit 20, the front drive shafts 24, the rear drive unit 50 and the rear drive shafts 54. The vehicle drive apparatus 10 is capable of front-wheel drive in which the torque is transmitted only to the front wheels 14f, and rear-wheel drive in which the torque is transmitted only to the rear wheels 14r.

Hereinafter, the front drive unit 20 will be described.

In the front drive unit 20, the engine 12, first planetary gear device 40, second planetary gear device 42, first electric motor MG1 and second electric motor MG2 are arranged coaxially, and their rotation axes correspond to a first axis C1. The first electric motor MG1 and second electric motor MG2 are both supported by a casing 18. The casing 18 is a non-rotating member, and is a casing that houses, for example, the front drive unit 20, etc.

The first planetary gear device 40 is a well-known double-pinion type planetary gear device having a first sun gear S1, first pinions P1, a first carrier CA1 and a first ring gear R1. The first pinions P1 mesh with the first sun gear S1 and the first ring gear R1. The first carrier CA1 supports the first pinions P1 such that the first pinions P1 are rotatable and revolvable. The first ring gear R1 has internal teeth and external teeth R1o, such that ed the internal teeth are provided on an inner periphery of its main body while the external teeth R1o are provided on an outer periphery of its 20) main body. The first pinion P1 consist of, for example, a plurality of pairs of inner pinions Pla and outer pinions P1b that mesh with each other. The first carrier CA1 is connected to the engine 12 through an engine connection shaft 30, and is also connected to the first electric motor MG1 through the second planetary gear device 42, as described below. The engine connection shaft 30 is an input shaft from the engine 12 to the front drive unit 20. The first sun gear S1 is connected to the second electric motor MG2 through a main shaft 32. The first ring gear R1 is connected to an auxiliary shaft 36 through a belt 38. Specifically, the belt 38 is mounted on the external teeth R1o of the first ring gear R1 and a driven gear 36g that is fixed to the auxiliary shaft 36 such that the driven gear 36g is unrotatable relative to the auxiliary shaft 36. The belt 38 is a flat-band-shaped member for transmitting the power, and may be, for example, a V-belt or chain belt. The auxiliary shaft 36 is an output shaft from the front drive unit 20 to the front differential gear device 22. The front differential gear device 22 connects the auxiliary shaft 36 to the left and right front drive shafts 24, so as to distribute the power transmitted to the auxiliary shaft 36, to the front drive shafts 24. A rotational axis of the auxiliary shaft 36 corresponds to the second axis C2, which is parallel to the first axis C1. The first planetary gear device 40 corresponds to “power transmission mechanism” recited in the appended claims. The auxiliary shaft 36 corresponds to “output shaft” recited in the appended claims.

The first carrier CA1, first sun gear S1 and first ring gear R1 correspond to the “first rotary element (RE1)”, “second rotary element (RE2)” and “third rotary element (RE3)”, respectively, which are recited in the appended claims. The first planetary gear device 40 functions as a differential mechanism configured to place the first carrier CA1, first sun gear S1 and first ring gear R1 in a differential state. For example, the first planetary gear device 40 is configured to mechanically divide the power inputted to the first carrier CA1, between the first sun gear S1 and the first ring gear R1.

For example, the second electric motor MG2 is rotationally driven by the power distributed to the second electric motor MG2 by the first planetary gear device 40. For example, the second electric motor MG2 generates an electric power by the power distributed to the second electric motor MG2. The first planetary gear device 40 functions as an electrically-continuously-variable transmission in which the differential state of the first planetary gear device 40 is controlled by controlling an operation state of the second electric motor MG2. The electric power generated by the second electric motor MG2 is used to charge the battery 62 or to drive the first electric motor MG1 and the third electric motor MG3.

The second planetary gear device 42 is a well-known single-pinion-type planetary gear device having a second sun gear S2, second pinions P2, a second carrier CA2 and a second ring gear R2. The second pinions P2 mesh with the second sun gear S2 and the second ring gear R2. The second carrier CA2 supports the second pinions P2 such that the second pinions P2 are rotatable and revolvable. The second ring gear R2 is connected to the casing 18. The second sun gear S2 is connected to the first electric motor MG1. The second carrier CA2 is connected to the engine 12 and the first carrier CA1 through the engine connection shaft 30. The second planetary gear device 42 functions as a speed reduction mechanism which connects the first electric motor MG1 to the first planetary gear device 40 in a power transmittable manner, and which is configured to transmit the power from the first electric motor MG1 while reducing a rotational speed. The second planetary gear device 42 corresponds to “speed reduction mechanism” recited in the appended claims.

The engine connection shaft 30 is provided with a brake BR. An end portion of the brake BR is connected to the engine connection shaft 30, while another end portion of the brake BR is connected to the casing 18. The brake BR is an engagement device that is to be operated by an electrically or hydraulically operated actuator, so as to selectively connect between the engine connection shaft 30 and the casing 18 that are connected to respective opposite end portions of the brake BR. The brake BR functions as a braking mechanism configured to selectively stop rotation of the engine connection shaft 30.

The rear drive unit 50 includes the transmission shaft 56 and the third electric motor MG3. The third electric motor MG3 is supported by, for example, a vehicle body 58, which is a non-rotating member. When the vehicle 60 is running in the four-wheel drive mode, for example, the rear drive unit 50 inputs the power of the third electric motor MG3 to the rear differential gear device 52.

For example, the rear drive unit 50 is a main drive unit to be used for driving the vehicle 60, with priority over the front drive unit 20. In this case, the front drive unit 20 serves as an auxiliary drive unit.

The third electric motor MG3 of the rear drive unit 50 is connected to the rear wheels 14r, and can therefore be considered to be connected to the front wheels 14f through a ground. By controlling the first electric motor MG1, second electric motor MG2, and third electric motor MG3 so that power is exchanged simultaneously, the vehicle 90 can be driven as if the third electric motor MG3 were connected to the front wheels 14f.

The vehicle 90 includes a shift operation device 64, a parking lock mechanism PLC and a parking brake 70, all of which are well-known components.

The shift operation device 64 includes a shift lever 66 that is to be operated to be positioned in positions “P,” “R,” “N,” and “D”, for example. The position “P” is a parking range position. The position “R” is a reverse range position that allows a reverse driving. The position “N” is a neutral range position. The position “D” is a forward range position that allows a forward driving.

The parking lock mechanism PLC is a well-known parking lock mechanism that can inhibit rotation of the front drive shaft 24. The parking lock mechanism PLC is located on a downstream side of the belt 38 in the first power transmission path PT1. The “located on the downstream side of the belt 38” means “located between the belt 38 and the front wheels 14f in the first power transmission path PT1 (through which the power is to be transmitted from the engine 12 to the front wheels 14f”. For example, the parking lock mechanism PLC is disposed on the auxiliary shaft 36. When the shift lever 66 of the shift operation device 64 is positioned in the position “P,” a parking gear 36p, which is fixed to the auxiliary shaft 36 so as to be unrotatable relative to the auxiliary shaft 36, is inhibited from being rotated by the parking lock mechanism PLC. This also inhibits the front drive shafts 24 and the front wheels 14f, which are fixed to the auxiliary shaft 36, from being rotated. Specifically, the parking lock mechanism PLC is configured to generate a locking force acting against the rotation of the auxiliary shaft 36, and to apply the locking force to an applied portion of the auxiliary shaft 36, by inhibiting the rotation of the parking gear 36p that is disposed in the applied portion of the auxiliary shaft 36, wherein the applied portion is located between the belt 38 and the front differential gear device 22 in the power transmission path PT1. On the other hand, when the parking lock mechanism PLC is released, the auxiliary shaft 36 is allowed to be rotated. This also allows the front drive shafts 24 and the front wheels 14f, which are connected to the auxiliary shaft 36, to be rotated.

The parking brake 70 is a well-known brake used to stop the vehicle 90 when the vehicle 90 is to be parked. The parking brake 70 includes, for example, a brake operator 72 and a brake cable 74. An amount of operation of the brake operator 72 is converted into a tension of the brake cable 74 and transmitted to, for example, wheel brakes 76 of the rear wheels 14r. The wheel brakes 76 of the rear wheels 14r is configured to apply a braking torque to the rear wheels 14r in accordance with the amount of operation of the brake operator 72 by the driver of the vehicle 90.

By the way, the belt 38 is a member with low rigidity, which means it is easily deformed. For example, as compared to the front drive shafts 24, front 20) differential gear device 22, auxiliary shaft 36 and first planetary gear device 40, the belt 38 is more easily deflected, namely, extended or contracted in the direction of rotation.

For example, when the vehicle 90 is stopped on an uphill or downhill road and the parking brake 70 is operated, if the parking brake 70 is released, the vehicle 90 may slide backward or forward, even in an activated state of the parking lock mechanism PLC. This is because a change in rotation occurs due to extension or contraction of components in the first power transmission path PT1 between the parking lock mechanism PLC and the front drive shafts 24 in the direction of rotation. However, in the present embodiment, the parking lock mechanism PLC is located on a downstream side of the belt 38 in the first power transmission path PT1. Therefore, when the parking brake 70 is released, an amount of sliding of the vehicle 90 backward or forward depends solely on the extension or contraction of the components in the first power transmission path PT1, i.e., the relatively rigid components excluding the belt 38, in the direction of rotation.

For example, when the parking lock mechanism PLC is started to be activated while the vehicle 90 is running at an extremely low speed, an impact load to inhibit rotation by the parking lock mechanism PLC is inputted to both the components located on an upstream side of the parking lock mechanism PLC in the first power transmission path PT1 and the components located on a downstream side of the parking lock mechanism PLC in the first power transmission path PT1. In this instance, a magnitude of the impact load inputted to the components arranged on the downstream from the parking lock mechanism PLC is larger than that inputted to the components arranged on the upstream side from the parking lock mechanism PLC. This is because the impact load inputted to the components arranged on the upstream side from the parking lock mechanism PLC serves to stop the engine 12, second electric motor MG2, etc. On the other hand, the impact load inputted to the components arranged on the downstream side from the parking lock mechanism PLC serves to stop the front wheels 14f, to which a weight of the vehicle 90 is added as a load, and the rear wheels 14r, which are connected to the front wheels 14f through the ground. In the present embodiment, the parking lock mechanism PLC is provided on the downstream side of the belt 38 in the first power transmission path PT1. Therefore, when the parking lock mechanism PLC is activated while the vehicle 90 is traveling at the extremely low speed, the belt 38 receives the impact load inputted from the parking lock mechanism PLC to the components located on the upstream side of the parking lock mechanism PLC.

The electronic control apparatus 80 includes a so-called microcomputer, and performs various controls of the vehicle 90 by processing signals according to programs stored in advance.

The electronic control apparatus 80 receives various signals based on detection signals from various sensors provided in the vehicle 90. These signals include, for example, signals indicative of a rotational speed of the engine 12 (engine rotational speed Ne [rpm]), a vehicle speed V [km/h], a first-electric-motor rotational speed Nmg1 [rpm], a second-electric-motor rotational speed Nmg2 [rpm], a third-electric-motor rotational speed Nmg3 [rpm], a throttle opening degree θacc [%], a shift-lever operation position POSop and a state of charge (SOC) [%]. The engine rotational speed Ne is a rotational speed of the engine 12. The first-electric-motor rotational speed Nmg1, second-electric-motor rotational speed Nmg2 and third-electric-motor rotational speed Nmg3 are rotational speeds of the first electric motor MG1, second electric motor MG2, and third electric motor MG3, respectively. The accelerator opening degree θacc represents a driver's accelerator operation amount, which indicates a magnitude of a driver's acceleration. The shift-lever operation position POSop represents an operation position of the shift lever 66, such as “P,” “R,” “N” or “D”. The state of charge (SOC) is a ratio of an actual amount of charge stored in the battery 62 to a predetermined full charge capacity, which is calculated based on, for example, a battery charge/discharge current and a battery voltage.

The electronic control apparatus 80 outputs various control signals such as an engine control signal Se for controlling an operation state of the engine 12, a first-electric-motor control signal Smg1 for controlling an operation state of the first electric motor MG1 through the inverter 60, a second-electric-motor control signal Smg2 for controlling an operation state of the second electric motor MG2 through the inverter 60, a third electric motor control signal Smg3 for controlling an operation state of the third electric motor MG3 through the invertor 60, and a brake control signal Sbr for controlling a connection/disconnection state of the brake BR. The outputted control signals are supplied to various devices such as the engine 12, inverter 60 and the brake BR.

The electronic control apparatus 80 controls the engine 12, first electric motor MG1, second electric motor MG2 and third electric motor MG3 so as to establish one of a plurality of drive modes. The electronic control apparatus 80 controls the brake BR such that the brake BR is engaged as needed when the drive modes are to be switched. For example, the plurality of drive modes include BEV_MG2 mode, series mode and output-split mode.

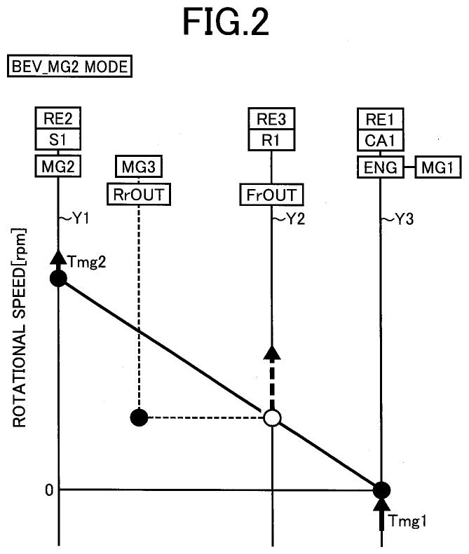

The plurality of drive modes of the vehicle 90, which can be switched, will be described with reference to FIGS. 2 through 4. Each of FIGS. 2 through 4 shows relative rotational speeds of the rotary elements RE1 through RE3 of the first planetary gear device 40. In the colinear charts, vertical lines Y1 through Y3 represent the rotational speeds of the first sun gear S1, first ring gear R1 and first carrier CA1 of the first planetary gear device 40, respectively. In FIGS. 2 through 4, “ENG” represents the engine 12, “FrOUT” represents the front wheels 14F and “RrOUT” represents the rear wheels 14r. Each arrow indicates magnitude and direction of torque. Solid arrows indicate the torque output from each actuator, and dashed arrow indicates the transmitted torque. In FIGS. 2 through 4, the rotational speeds (Nmg1, Nmg3) and torques (Tmg1, Tmg3) of the first electric motor MG1 and third electric motor MG3 are shown as converted values on the first carrier CA1 and first ring gear R1, respectively.

FIG. 2 is a colinear chart showing the BEV_MG2 mode. In the BEV_MG2 mode, the engine 12 is stopped while the first electric motor MG1 and second electric motor MG2 are caused to generate the torque, thereby enabling BEV (Battery Electric Vehicle) driving. In the BEV_MG2 mode, the first electric motor MG1 and second electric motor MG2 transfer the power with the battery 62, thereby generating mutual torque so as to zero a moment around the third rotary element RE3, and enabling the BEV driving. In this instance, the first electric motor torque Tmg1 is controlled to prevent drag from the engine 12, i.e., to zero the rotational speed of the first rotary element RE1. In the BEV_MG2 mode, the first planetary gear device 40 is in a differential state, and the first electric motor MG1 and second electric motor MG2 are caused to generate the torque is generated in the first electric motor MG1 and the second electric motor MG2, whereby the generated torque is mechanically transmitted to the third rotary element RE3 serving as an output element. Furthermore, in the BEV_MG2 mode, the torque can be generated also in the third electric motor MG3, thereby enabling 4WD driving and increasing drive torque.

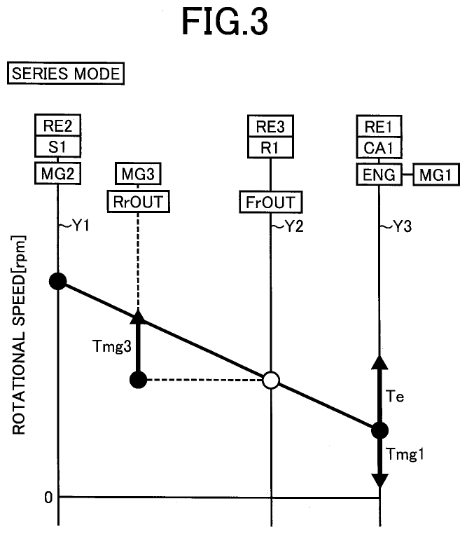

FIG. 3 is a colinear chart showing the series mode. In the series mode, the brake BR is released, the engine 12 is placed in an operated state, and the third electric motor MG3 is caused, by the power generated by the first electric motor MG1, to output the third electric motor torque Tmg3 as a positive torque. The series mode enables HEV (Hybrid Electric Vehicle) driving and series driving using the engine 12 as the power source. In the series mode, the first electric motor torque Tmg1 serves as a negative torque, and the first electric motor MG1 is operated as an electric generator by the power of the engine 12, while the third electric motor MG3 is operated as an electric motor. In the series mode, explosive vibrations of engine 12 are not transmitted to the front drive shafts 24, which is advantageous for reducing muffled noises.

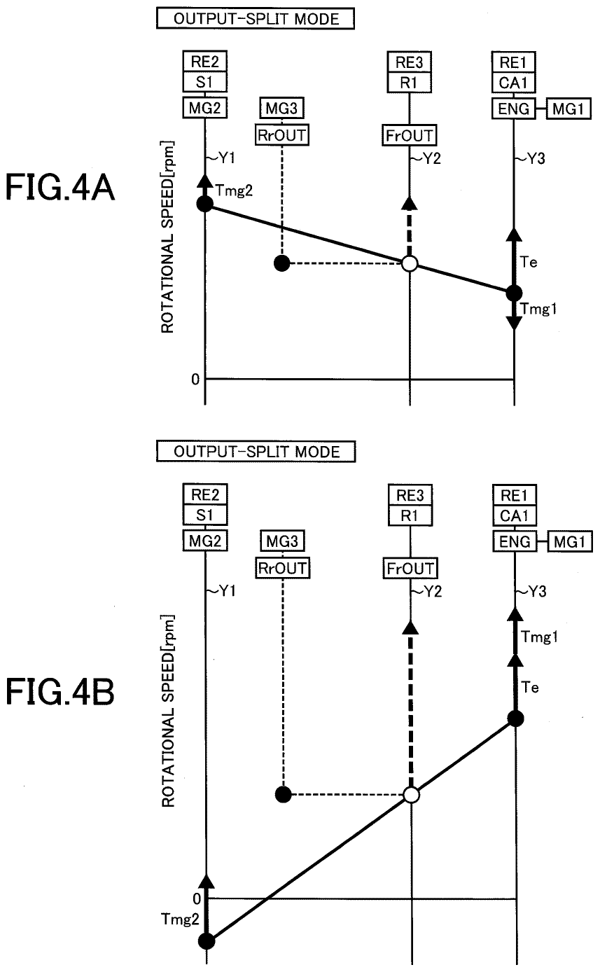

FIGS. 4A and 4B are collinear charts for explaining the output-split mode. In the output-split mode, the brake BR is released, the engine 12 is placed in the operated state, and states of the first and second electric motors MG1, MG2 are controlled to balance the power consumption of the two electric motors MG1, MG2. In the output-split mode, one of the first and second electric motors MG1, MG2 is operated as an electric motor, and the other is operated as an electric generator. The output-split mode enables the HEV driving and output-split driving using the engine 12 as the power source. As shown in FIG. 4A, when the second electric motor MG2 is rotated in a positive direction in the output split mode, the second electric motor torque Tmg2 serves as a positive torque, so that the second electric motor MG2 is controlled to be operated as an electric motor, and the first electric motor torque Tmg1 serves as a negative torque, so that the first electric motor MG1 is controlled to operated as an electric generator. As shown in FIG. 4B, when the second electric motor MG2 is rotated in a negative direction in the output split mode, the second electric motor torque Tmg2 serves as a positive torque, so that the second electric motor MG2 is controlled to be operated as an electric generator, and the first electric motor torque Tmg1 serves as a positive torque, so that the first electric motor MG1 is controlled to be operated as an electric motor. The first planetary gear device 40 is in a differential state, and torque is mechanically transmitted to the first ring gear R1 by the second electric motor MG2 that receives a reaction force of a combined torque Tsum (=Te+Tmg1) of the engine torque Te and the first electric motor torque Tmg1. The third electric motor MG3 is in a non-operated state.

The plurality of switchable drive modes of the vehicle 90 have been described with reference to FIGS. 2 through 4. However, the vehicle 90 can be placed in other modes that are other than the above-described drive modes.

In the present embodiment, the vehicle drive apparatus 10 includes: the engine 12; the first planetary gear device 40 disposed on the first axis C1 and configured to transmit the power from the engine 12; the auxiliary shaft 36 disposed on the second axis C2 other than the first axis C1 and configured to transmit the power to the front drive shafts 24; the belt 38 configured to transmit the power from the first planetary gear device 40 to the auxiliary shaft 36; and the parking lock mechanism PLC configured to inhibit rotation of the front drive shafts 24, wherein the parking lock mechanism PLC is disposed on the downstream side of the belt 38 in the power transmission path PT1 through which the power is to be transmitted from the engine 12 to the front drive shafts 24. Thus, since the parking lock mechanism PLC is provided on the auxiliary shaft 36 and is located on the downstream side of the belt 38 in the first power transmission path PT1, movement or rotation of the front drive shafts 24 due to deflection of the belt 38 when the parking brake 70 is released is suppressed as compared to an arrangement in which the parking brake 70 is not located on the downstream side of the belt 38. Furthermore, since the parking lock mechanism PLC is located on the downstream side of the belt 38 in the first power transmission path PT1, the impact load applied from the parking lock mechanism PLC to the belt 38 when the parking lock mechanism PLC is activated is suppressed as compared to the arrangement in which the parking brake 70 is not located on the downstream side of the belt 38, thereby suppressing reduction of durability of the belt 38.

In the present embodiment, (a) the power transmitted from the first planetary gear device 40 to the auxiliary shaft 36 is the power from the engine 12, (b) the first electric motor MG1, the second electric motor MG2 and the second planetary gear device 42, which connects the first electric motor MG1 to the first planetary gear device 40 in the power transmittable manner while reducing the rotational speed below the first-electric-motor rotational speed Nmg1, are provided, and (c) the first planetary gear device 40 has three rotary elements consisting of the first rotary element RE1, second rotary element RE2 and third rotary element RE3, such that the engine 12 is connected to the first rotary element RE1, the first electric motor MG1 is connected through the second planetary gear device 42, the second rotary element RE2 is connected to the second electric motor MG2, and the auxiliary shaft 36 is connected to the third rotary element RE3 through the belt 38. Owing to these constructions, the drive modes of the vehicle 90 can include, for example, the output split mode and the BEV_MG2 mode. Therefore, where the first electric motor MG1 and the second planetary gear device 42 are provided, more various kinds of drive modes can be realized as compared to an arrangement without these constructions.

In the present embodiment, the first planetary gear device 40, the second planetary gear device 42, the first electric motor MG1 and the second electric motor MG2 are disposed on the first axis C1 as a common axis. Thus, it is possible to make a radial dimension of the front drive unit 20 smaller than in an arrangement in which the first planetary gear device 40, the second planetary gear device 42, the first electric motor MG1 and the second electric motor MG2 are not disposed on the common axis.

In the present embodiment, the vehicle drive apparatus 10 further includes the third electric motor MG3 configured to apply the power to the rear drive shafts 54. Owing to the third electric motor MG3, the drive modes of the vehicle 90 can include the series mode, for example. Thus, where the rear drive unit 50 is provided, more various kinds of drive modes can be realized as compared to an arrangement without the rear drive unit 50.

### Second Embodiment

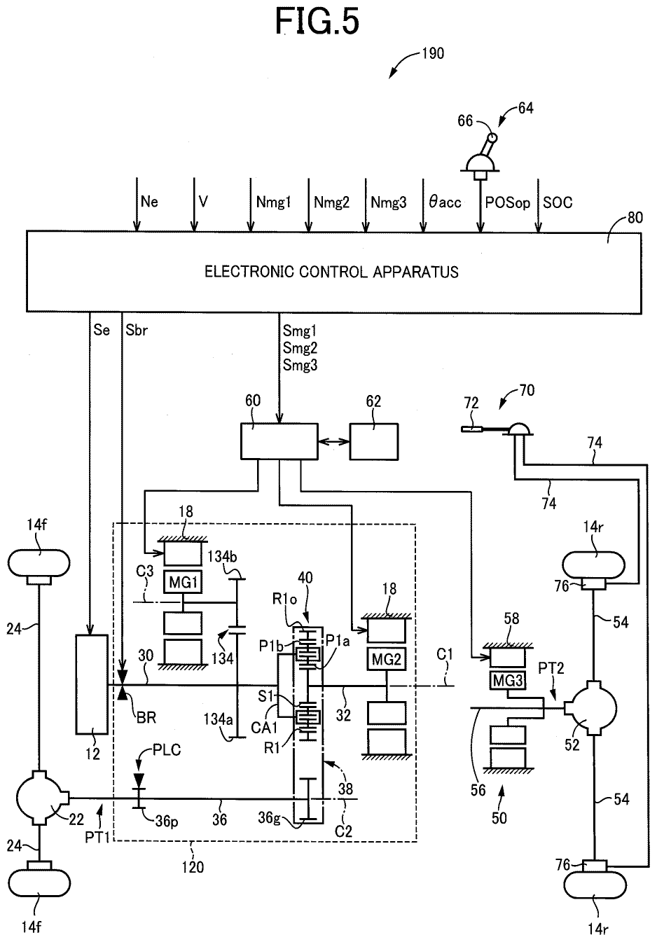

FIG. 5 is a schematic view showing a vehicle 190 equipped with a vehicle drive apparatus 110 according to a second embodiment of the present invention. The vehicle 190 has substantially the same construction as the vehicle 90 in the above-described first embodiment, except that a front drive unit 120 is used in place of the front drive unit 20. Therefore, in this second embodiment, differences from the first embodiment will be mainly described. Components that are substantially the same in function as those in the first embodiment will be assigned the same reference signs and will not be described as appropriate.

The front drive unit 120 has substantially the same construction as the front drive unit 20, except that a pair of gears 134 are used in place of the second planetary gear device 42 as a speed reduction mechanism, and that the second planetary gear device 42 is not provided.

The first electric motor MG1 is disposed on the third axis C3 that is parallel to the first axis C1. The First electric motor MG1 is connected to the first 35 carrier CA1 through the pair of gears 134 that are connected to the engine 12. The pair of gears 134 consists of a large-diameter gear 134a and a small-diameter gear 134b that mesh with each other. The large-diameter gear 134a is fixedly mounted on the engine connection shaft 30 so as to be unrotatable relative to the engine connection shaft 30, while the small-diameter gear 134b is fixedly mounted on a rotor shaft of the first electric motor MG1 so as to be unrotatable relative to the rotor shaft of the first electric motor MG1. The large-diameter gear 134a has a larger diameter than the small-diameter gear 134b.

The pair of gears 134 functions as a speed reduction mechanism which connects the first electric motor MG1 to the engine 12 in a power transmittable manner, and which is configured to transmit the power from the first electric motor MG1 while reducing a rotational speed. The pair of gears 134 correspond to “speed reduction mechanism” recited in the appended claims. When the first electric motor MG1 functions as an electric generator, the first electric motor torque Tmg1 is added to the engine torque Te while the rotational speed is being slowed down below the first-electric-motor rotational speed Nmg1 [rpm] by the pair of gears 134, and the torque is inputted to the first carrier CA1. When the first electric motor MG1 functions as an electric generator, the first electric motor MG1 is rotated by the engine torque Te while the rotational speed is being accelerated above the engine rotational speed Ne by the pair of gears 134.

As in the above-described first embodiment, in this second embodiment, the plurality of drive modes include, for example, the BEV_MG2 mode, series mode and output split mode.

According to this second embodiment, owing to substantially the same construction as the above-described first embodiment, substantially the same effects can be obtained as in the first embodiment.

### Third Embodiment

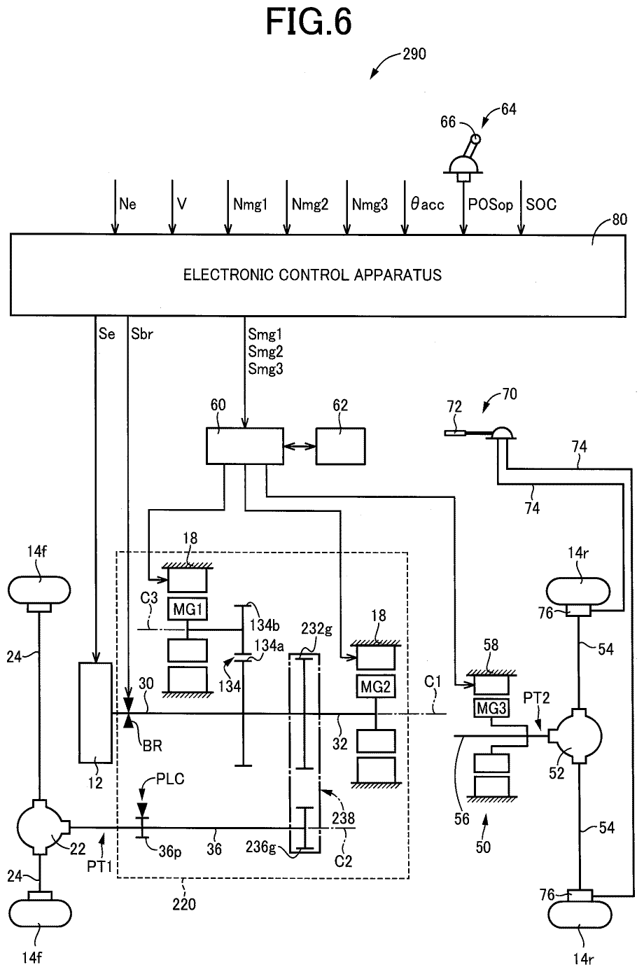

FIG. 6 is a schematic view showing a vehicle 290 equipped with a vehicle drive apparatus 210 according to a third embodiment of the present invention. The vehicle 290 has substantially the same construction as the vehicle 190 according to the above-described second embodiment, except that a front drive unit 220 is provided in place of the front drive unit 120. Therefore, in this third embodiment, differences from the second embodiment will be mainly described. Components that are substantially the same in function as those in the first embodiment will be assigned the same reference signs and will not be described as appropriate.

The front drive unit 220 has substantially the same construction as the above-described front drive unit 120 except that the first planetary gear device 40 is not provided.

The front drive unit 220 includes a drive gear 232g fixedly mounted on the main shaft 32 and non-rotatable relative to the main shaft 32, a driven gear 236g fixedly mounted on the auxiliary shaft 36 and non-rotatable relative to the auxiliary shaft 36, and a belt 238 wound around the drive gear 232g and the driven gear 236g. The drive gear 232g corresponds to “power transmission mechanism” recited in the appended claims.

As in the above-described second embodiment, in this third embodiment, the plurality of drive modes include, for example, the BEV_MG2 mode, series mode and output split mode.

According to this third embodiment, owing to substantially the same construction as the above-described second embodiment, substantially the same effects can be obtained as in the second embodiment.

The above-described embodiments of the present invention are examples of the present invention, and various modifications and improvements can be made based on the knowledge of those skilled in the art without departing from the spirit of the present invention.

In the above-described first, second and third embodiments, the engine 12 corresponds to the “prime mover” in the present invention. However, the “prime mover” in the present invention is not limited to the engine 12 but may be any component as long as it functions as a power source for driving the vehicle.

In the above-described first and second embodiments, the first planetary gear device 40 is a double-pinion type, but the present invention is not limited to this 25 detail. For example, the present invention is also applicable to an arrangement in which the first planetary gear device 40 is a single-pinion type.

In the above-described first and second embodiments, the second planetary gear device 42 is a single-pinion type, but the present invention is not limited to this detail. For example, the present invention is also applicable to an arrangement in which the second planetary gear device 42 is a double-pinion type.

In the above-described first and second embodiments, the brake mechanism configured to stop rotation of the first rotary element RE1 may be a one-way clutch in place of the brake BR. In the above-described third embodiment, the brake mechanism configured to stop rotation of the engine 12 may be a one-way clutch in place of the brake BR. Furthermore, the brake BR is not necessarily provided in the above-described first, second and third embodiments.

In the above-described first, second and third embodiments, the rear drive unit 50 is provided with the third electric motor MG3. However, the present invention is also applicable to an arrangement without the electric motor MG3. In such an arrangement, the plurality of switchable drive modes of vehicle do not include a mode using the third electric motor MG3.

In the above-described first, second and third embodiments, the power of engine 12 or second electric motor MG2 may be transmitted to the rear wheels 14r, while the power of third electric motor MG3 may be transmitted to the front wheels 14f. That is, the rear drive shafts 54 may correspond to “first pair of axles” recited in the appended claims, while the front drive shafts 24 may correspond to “second pair of axles” recited in the appended claims.

### NOMENCLATURE OF ELEMENTS

10, 110, 210: vehicle drive apparatus
12: engine (prime mover)
22: front differential gear device (differential gear device)
24: left and right front drive shafts (pair of axles, first pair of axles)
36: auxiliary shaft (output shaft)
38: belt
40: first planetary gear device (power transmission mechanism)
42: second planetary gear device (speed reduction mechanism)
54: left and right rear drive shafts (second pair of axles)
134: gear pair (speed reduction mechanism)
232g: drive gear (power transmission mechanism)
238: belt
C1: first axis
C2: second axis
MG1: first electric motor
MG2: second electric motor
MG3: third electric motor
Nmg1: first electric-motor rotational speed (rotational speed of first electric motor)
PLC: parking lock mechanism
RE1: first rotary element
RE2: second rotary element
RE3: third rotary element

What is claimed is:

1. A vehicle drive apparatus comprising:
a prime mover;
a power transmission mechanism disposed on a first axis and configured to transmit a power from the prime mover;
an output shaft disposed on a second axis other than the first axis and configured to transmit the power to a pair of axles;
a belt configured to transmit the power from the power transmission mechanism to the output shaft; and
a parking lock mechanism configured to inhibit rotation of the axles,
wherein the parking lock mechanism is disposed on a downstream side of the belt in a power transmission path through which the power is to be transmitted from the prime mover to the axles.

2. The vehicle drive apparatus according to claim 1, further comprising:
a first electric motor;
a second electric motor; and
a speed reduction mechanism which connects the first electric motor to a first planetary gear device constituted by the power transmission mechanism, in a power transmittable manner, and which is configured to transmit the power from the first electric motor to the first planetary gear device while reducing a rotational speed,
wherein the first planetary gear device includes a first rotary element, a second rotary element and a third rotary element, such that the first rotary element is connected to an engine constituted by the prime mover and is connected to the first electric motor through the speed reduction mechanism, such that the second rotary element is connected to the second electric motor, and the third rotary element is connected to the output shaft through the belt.

3. The vehicle drive apparatus according to claim 2,
wherein the speed reduction mechanism is a second planetary gear device, and
wherein the second planetary gear device, the first electric motor and the second electric motor are disposed on the first axis.

4. The vehicle drive apparatus according to claim 2, further comprising a third electric motor configured to apply the power to a second pair of axles that are other than the pair of axles as a first pair of axles.

5. The vehicle drive apparatus according to claim 1, further comprising a differential gear device which connects the output shaft to the pair of axles, so as to distribute the power transmitted to the output shaft, to the pair of axles,
wherein the parking lock mechanism is configured to generate a locking force acting against rotation of the output shaft, and to apply the locking force to an applied portion of the output shaft, such that the applied portion is located between the belt and the differential gear device in the power transmission path.
